(19) United States
(12) Patent Application Publication
(10) Pub. No.: US 2007/0232708 A1
(43) Pub. Date: Oct. 4, 2007

(54) Method for forming a sole shape for footwear and for a cup insole, and article

(75) Inventors: Michihiko Kubota, Shizuoka-shi (JP); Ryogo Kubota, Shizuoka-shi (JP)

Correspondence Address: KANESAKA BERNER AND PARTNERS LLP, 1700 DIAGONAL RD, SUITE 310, ALEXANDRIA, VA, 22314-2848, US

(73) Assignee: KUBOTA SANGYO CO., LTD., Shizuoka-shi (JP)

(21) Appl. No.: 11/641,074

(22) Filed: Dec. 19, 2006

(30) Foreign Application Priority Data
Mar. 9, 2006 (JP) 2006-063729
Oct. 20, 2006 (JP) 2006-286026

(51) Int. Cl. C08J 9/00

(52) U.S. Cl. 521/50

(57) ABSTRACT

A sole includes a closed cell resin foam of a low-density polyethylene (A), ethylene-vinyl acetate copolymer (B), filler (C), foaming agent (D), and cross-linker (E), wherein a mass ratio of the low-density polyethylene (A) and the ethylene-vinyl acetate copolymer (B) equals (A)/(B) within a range 90/10 to 95/5. The resin foam, molded into a predetermined middle padding member, is deformable by an external force. An elastic covering member covers the middle padding member and is configured to follow the deformation of the middle padding member abutting the covering member configured to be abutted against a foot. Weight applied to the sole crushes, and deforms a plurality of bubbles formed in the resin foam along the shape of the sole.

### BACKGROUND OF THE INVENTION AND RELATED ART STATEMENT

The present invention relates to a method for forming a sole shape for footwear and a method for forming a sole shape for a cup insole capable of easily retaining its shape when deformed by body weight, and an article formed by the method.

Footwear is required to have the function of absorbing a shock when the footwear is grounded, and reducing the burden imposed on a foot. Furthermore, even if the footwear is used for a long time, it should not tire the person wearing the footwear. Therefore, the insole is desired to be formed into the shape of each person's sole in order not to break the balance of the body. For example, there is footwear wherein a sponge that changes shape due to one's weight is used as an insole (refer to Japanese Utility Model Registration No. 3097517). Footwear is further available wherein the shape of the sole is molded by using thermoplastic resin for insole materials. Before the footwear is used, the thermoplastic resin is heated and the foot is inserted (refer to Japanese Patent Publication (KOKAI) No. 2005-74085).

However, as far as the first example is concerned, specific insole materials cable to easily retain a shape that is deformed by weight have not been disclosed. Because the second example requires the thermoplastic resin of the insole be heated and molded so as to fit in the shape of the sole before the footwear is used, this method requires time and labor.

The present invention eliminates the above-mentioned problems, providing a method for forming a sole shape of the footwear and a method for forming a sole shape of the cup insole that can easily retain a shape deformed by weight.

Further objects and advantages of the invention will be apparent from the following description of the invention.

### SUMMARY OF INVENTION

The invention according to a first aspect is footwear wherein an insole is provided on an outsole. The insole includes a middle padding member comprised a resin foam and a covering member covering the outer surface of the middle padding member. The resin foam is a foamed resin composition including low-density polyethylene (A), ethylene-vinyl acetate copolymer (B), filler (C), foaming agent (D), and cross-linker (E). The mass ratio of the low-density polyethylene (A) and the ethylene-vinyl acetate copolymer (B) is set in (A)/(B)=95/5˜90/10. A foot is abutted against the covering member, and one's weight on the sole allows a bubble in the resin foam to be crushed, plastic-deformed, and deformed along the shape of the sole.

The invention according to a second aspect is a method for forming a sole shape for a cup insole including a middle padding member comprised of the resin foam. A covering member is further provided in such a way as to cover the whole middle padding member. The resin foam is a foamed resin composition including low-density polyethylene (A), ethylene-vinyl acetate copolymer (B), filler (C), foaming agent (D), and cross-linker (E). The mass ratio of the low-density polyethylene (A) and ethylene-vinyl acetate copolymer (B) is set in (A)/(B)=95/5˜90/10. The foot is abutted against said covering member, and the weight on the sole allows the bubble in said resin foam to be crushed, plastic-deformed, and deformed along the shape of the sole.

The invention according to a third aspect, includes the method for forming the sole shape for the footwear according to the first aspect, and further includes a sheet-like supporting member which has the same shape as the middle padding member in plan view. The sheet-like supporting member is located under the middle padding member and is harder than the middle padding member. The sheet-like supporting member and supports the middle padding member. A covering member covers at least the upper surface of the middle padding member, and an abutting surface between said middle padding member and the supporting member is adhered by an adhesive.

A fourth aspect includes the method of forming the sole shape for the footwear according to the first aspect, including a sheet-like supporting member that has the same shape as the middle padding member in plan view. The sheet-like supporting member is located under the middle padding member, is harder than the middle padding member, and supports the middle padding member. The covering member includes a rim turned back and located on an undersurface of the supporting member, while covering the upper surface of the middle padding member. An abutting surface is provided between the turnback of the covering member and the supporting member is adhered by an adhesive.

The invention according to the fifth aspect is the method for forming the sole shape for the footwear according to the first aspect, and further includes the sheet-like supporting member which has the same shape as the middle padding member in plan view. The sheet-like supporting member is located under the middle padding member, is harder than the middle padding member, and supports the middle padding member. A covering member covers at least the upper surface of the middle padding member, and the abutting surface between the middle padding member and the supporting member is adhered by the adhesive. A blocking member projecting toward the covering member and blocking the movement of the heel is provided at the site corresponding to a border between a heel and an arch between the middle padding member and the supporting member, or between the supporting member and the outsole.

The invention according to a sixth aspect includes the method for forming the sole shape according to the first aspect. The sixth aspect includes a sheet-like supporting member having the same shape as the middle padding member in plan view, is located under the middle padding member, is harder than the middle padding member, and supports the middle padding member. The covering member includes a rim turned back and located on the undersurface of the supporting member. The covering member covers the upper surface of the middle padding member, and an abutting surface, between the turnback of the covering member and the supporting member, is adhered by the adhesive. A blocking member projecting toward the covering member and blocking the movement of the heel is provided at the site corresponding to the border between the heel and the arch between the middle padding member and the supporting member, or between the supporting member and the outsole.

The invention according to a seventh aspect includes the method according to the second aspect, wherein the sheet-like supporting member has the same shape as the middle padding member in plan view, is located under the middle padding member, is harder than the middle padding member, and supports the middle padding member. The covering member covers at least the upper surface of the middle padding member, and the abutting surface between the middle padding member and the supporting member is adhered by adhesive.

The invention according to an eighth aspect includes the method according to the second aspect. The sheet-like supporting member which has the same shape as the middle padding member in plan view, is located under the middle padding member and harder than the middle padding member, and supports the middle padding member; and the covering member whose rim is turned back and located on the undersurface of the supporting member while covering the upper surface of the middle padding member, and the abutting surface between the turnback of the covering member and the supporting member is adhered by the adhesive.

The invention according to the ninth aspect, includes the method according to the second aspect, wherein the sheet-like supporting member that has the same shape as the middle padding member in plan view, is located under the middle padding member and harder than the middle padding member, and supports the middle padding member. The covering member covering at least the upper surface of the middle padding member, and the abutting surface between the middle padding member and the supporting member is adhered by the adhesive. A blocking member projecting toward the covering member and blocking the movement of the heel is provided at the site corresponding to the border between the heel and the arch between the middle padding member and the supporting member, or on the underside of the supporting member.

A tenth aspect, wherein the sheet-like supporting member has the same shape as the middle padding member in plan view, is located under the middle padding member and is harder than the middle padding member. The supporting member supports the middle padding member. The covering member, whose rim is turned back, is located on the undersurface of the supporting member while covering the upper surface of the middle padding member. In addition, the abutting surface between the turnback of the covering member and the supporting member is adhered by the adhesive. A blocking member projects toward the covering member and blocks the movement of the heel. The blocking member is provided at a site corresponding to the border between the heel and the arch between the middle padding member and the supporting member, or, alternatively, on the underside of the supporting member.

According to an eleventh aspect, the ratio between the total mass of the low-density polyethylene (A) and the ethylene-vinyl acetate copolymer (B); and the mass of the filler (C) determined according to the formula ((A)+(B))/(C) and is in the range 70/30-80/20.

According to a twelfth aspect based upon the insole of the second aspect, the ratio between the total mass of the low-density polyethylene (A) and the ethylene-vinyl acetate copolymer (B); and the mass of the filler (C) becomes ((A)+(B))/(C)=70/30˜80/20.

According to sole shape described in the first aspect, the middle padding member of the insole of the footwear is made by a foamed resin composition including the low-density polyethylene (A); the ethylene-vinyl acetate copolymer (B); the filler (C); the foaming agent (D); and the cross-linker (E); and composed of the resin foam wherein the mass ratio between the low-density polyethylene (A) and the ethylene-vinyl acetate copolymer (B) is set in (A)/(B)=95/5˜90/10. As a result, the shape of the sole which varies according to each person can be molded on the surface of the insole in a short time by use of the footwear, and footwear which fits in each person's sole shape can be obtained without labor and time.

According to the invention described in the second aspect, the middle padding member of the cup insole is made by a foamed resin composition including the low-density polyethylene (A); the ethylene-vinyl acetate copolymer (B); the filler (C); the foaming agent (D); and the cross-linker (E); and composed of resin foam wherein the mass ratio between the low-density polyethylene (A) and the ethylene-vinyl acetate copolymer (B) is set in (A)/(B)=95/5˜90/10. As a result, the shape of the sole which varies according to each person can be molded on the surface of the cup insole in a short time by use of the footwear wherein the cup insole is placed, and footwear which fits in each person's sole shape can be obtained without taking labor and time.

According to the invention described in the third aspect, in addition to the effect of the invention described in the first aspect, since the middle padding member and the supporting member have the same shape in plan view, the sheet-like middle padding member and supporting member are overlapped and laminated, and can be integrally formed by simple means wherein the abutting surface between the middle padding member and supporting member is adhered by the adhesive. As a result, footwear with an insole which can be fitted in the uneven shape of each person's sole can be easily obtained. Also, since the middle padding member and the supporting member are integrally formed, the deformation in a roughly horizontal direction of the middle padding member can be prevented by being restricted by the supporting member.

A fourth aspect includes the invention described in the first aspect. Because the middle padding member and the supporting member have the same shape in plan view, the sheet-like middle padding member and supporting member are overlapped and laminated and the covering member covers the upper surface of the middle padding member. In addition, the rim of the covering member is turned back and the abutting surface between the turnback and the undersurface of the supporting member is adhesively adhered, whereby the middle padding member and the supporting member may be integrally formed. As a result, footwear comprising an insole that can be fitted in the uneven shape of each person's sole may be easily obtained. Also, since the middle padding member and the supporting member are integrally formed, the deformation in the roughly horizontal direction of the middle padding member may be prevented by being restricted by the supporting member.

According to a fifth aspect, in addition to the effect of the invention described in the first aspect, because the middle padding member and the supporting member have the same shape in plan view, the middle padding member and the supporting member can be integrally formed wherein the sheet-like middle padding member and supporting member are overlapped and laminated, and the abutting surface between the middle padding member and the supporting member is adhered by the adhesive. As a result, footwear comprising an insole that can be fitted in the uneven shape of each person's sole can be easily obtained. Also, since the middle padding member and the supporting member are integrally formed, the deformation in the roughly horizontal direction of the middle padding member can be prevented by being restricted by the supporting member. Moreover, since the blocking member projecting toward the covering member and blocking the movement of the heel is provided at the site corresponding to the border between the heel and the arch between the middle padding member and the supporting member, or between the supporting member and the outsole, the blocking member can prevent the movement of the heel and allows itself to be fitted into the shape of each person's sole formed on the upper surface of the insole.

According to a sixth aspect, in addition to the effect of the invention described in the first aspect, since the middle padding member and the supporting member have the same shape in plan view, the middle padding member and the supporting member can be integrally formed by wherein the sheet-like middle padding member and supporting member are overlapped and laminated, the covering member covers the upper surface of the middle padding member, the rim of the covering member is turned back, and the abutting surface between the turnback and the undersurface of the supporting member is adhered by adhesive. Herewith, footwear with an insole that can be fitted in the uneven shape of each person's sole can be easily obtained. Also, because the middle padding member and the supporting member are integrally formed, the deformation in the roughly horizontal direction of the middle padding member may be prevented by being restricted by the supporting member. Moreover, a blocking member projecting toward the covering member and blocking the movement of the heel is provided either at the site corresponding to the border between the heel and the arch between the middle padding member and the supporting member, or between the supporting member and the outsole, so that the blocking member can prevent the movement of the heel and allows itself to be fitted into the shape of each person's sole formed on the upper surface of the insole.

According to a seventh aspect, in addition to the effect of the invention described in the second aspect, since the middle padding member and the supporting member have the same shape in plan view, the middle padding member and the supporting member can be integrally formed wherein the sheet-like middle padding member and supporting member are overlapped and laminated, and the abutting surface between the middle padding member and the supporting member is adhered by the adhesive. Accordingly, a cup insole that can be fitted in the uneven shape of each person's sole may be easily obtained. Also, since the middle padding member and the supporting member are integrally formed, the deformation in the roughly horizontal direction of the middle padding member can be prevented by being restricted by the supporting member.

According to an eighth aspect, in addition to the effect of the invention described in the second aspect, because the middle padding member and the supporting member have the same shape in plan view, the middle padding member and the supporting member can be integrally formed wherein the sheet-like middle padding member and supporting member are overlapped and laminated; the covering member covers the upper surface of the middle padding member; the rim of the covering member is turned back; and the abutting surface between the turnback and the undersurface of the supporting member is adhered by the adhesive. Accordingly, a cup insole that can be fitted in the uneven shape of each person's sole can be easily obtained. Also, since the middle padding member and the supporting member are integrally formed, the deformation in the roughly horizontal direction of the middle padding member can be prevented by being restricted by the supporting member.

According to a ninth aspect, in addition to the effect of the invention described in the second aspect, since the middle padding member and the supporting member have the same shape in plan view, the middle padding member and the supporting member can be integrally formed wherein the sheet-like middle padding member and supporting member are overlapped and laminated; and the abutting surface between the middle padding member and the supporting member is adhered by the adhesive. Accordingly, a cup insole that can be fitted in the uneven shape of each person's sole can be easily obtained. Also, since the middle padding member and the supporting member are integrally formed, the deformation in the roughly horizontal direction of the middle padding member can be prevented by being restricted by the supporting member. Moreover, a blocking member projecting toward the covering member and blocking the movement of the heel is provided at the site corresponding to the border between the heel and the arch between the middle padding member and the supporting member, or on the underside of the supporting member, so that the blocking member can prevent the movement of the heel and allows itself to be fitted in the shape of each person's sole formed on the upper surface of the cup insole.

According to a tenth aspect, in addition to the effect of the invention described in the second aspect, since the middle padding member and the supporting member have the same shape in plan view, the middle padding member and the supporting member can be integrally formed wherein the sheet-like middle padding member and supporting member are overlapped and laminated. The covering member covers the upper surface of the middle padding member and the rim of the covering member is turned back, and the abutting surface between the turnback and the undersurface of the supporting member is adhered by adhesive. Accordingly, a cup insole which can be fitted in the uneven shape of each person's sole can be easily obtained. Also, since the middle padding member and the supporting member are integrally formed, the deformation in the roughly horizontal direction of the middle padding member can be prevented by being restricted by the supporting member. Moreover, a blocking member projecting toward the covering member and blocking the movement of the heel is provided at the site corresponding to the border between the heel and the arch between the middle padding member and the supporting member, or on the underside of the supporting member, so that the blocking member can prevent movement of the heel and allows itself to be fitted in the shape of each person's sole formed on the upper surface of the cup insole.

According to an eleventh aspect, in addition to the effect of the invention described in the first aspect, in regards to resin foam, the ratio between the total mass of the low-density polyethylene (A) and the ethylene-vinyl acetate copolymer (B); and the mass of the filler (C) is set in ((A)+(B))/(C)=70/30˜80/20. Accordingly, footwear may be provided that comprises a degree of hardness that provides an appropriate feel for the sole when the footwear is put on.

According to a twelfth aspect, in addition to the effect of the invention described in the second aspect, regarding the resin foam, the ratio between the total mass of the low-density polyethylene (A) and the ethylene-vinyl acetate copolymer (B); and the mass of the filler (C) is set such that ((A)+(B))/(C)=70/30˜80/20. Accordingly, a cup insole may be provided that comprises a degree of hardness that provides the appropriate feel for the sole when the footwear with the cup insole is put on.

### BRIEF DESCRIPTION OF THE DRAWING

FIG. 1 is a schematic cross sectional view of a resin foam that may be used to form a sole shape for footwear and a sole shape for a cup insole;

FIG. 2 is a perspective view of the footwear using the resin foam according to FIG. 1;

FIG. 3 is a longitudinal sectional view taken along line 3-3 in FIG. 2;

FIG. 4 is a horizontal sectional view taken along line 4-4 in FIG. 3;

FIGS. 5(a) and 5(b) are longitudinal sectional views showing usage states of the footwear in FIG. 2, wherein FIG. 5(a) is a view showing the state where the footwear is put on, and FIG. 5(b) is a view showing the state where the footwear is taken off;

FIGS. 6(a) and 6(b) are longitudinal sectional views taken along line 6-6 in FIG. 2, wherein FIG. 6(a) is a view showing the state where the footwear is unused and FIG. 6(b) is a view showing the state where the footwear is used;

FIGS. 7(a) and 7(b) are longitudinal sectional views taken along line 7-7 in FIG. 2, wherein FIG. 7(a) is a view showing the state where the footwear is unused, and FIG. 7(b) is a view showing the state where the footwear is used;

FIGS. 8(a) and 8(b) are views showing the cup insole of an embodiment according to the formation method for the sole shape for the cup insole of the present invention, wherein FIG. 8(a) is a perspective view of the cup insole, and FIG. 8(b) is a longitudinal sectional view taken along line 8(b)-8(b) in FIG. 8(a);

FIG. 9 is a perspective view wherein a part of the footwear of another embodiment according to the method for forming the sole shape for the footwear of the present invention, is cut off;

FIGS. 10(a) and 10(b) are longitudinal sectional views taken along line 10-10 in FIG. 9, wherein FIG. 10(a) shows unused footwear, and FIG. 10(b) shows the footwear when used;

FIG. 11 is another embodiment of the insole of the footwear in FIG. 9, and illustrates a perspective view wherein a part of the insole is cut off;

FIGS. 12(a) and 12(b) are longitudinal sectional views showing another example of the embodiment in FIG. 9, wherein FIG. 12(a) shows an example where a blocking member is provided between a middle padding member and a supporting member, and FIG. 12(b) shows an example where the blocking member is provided between the supporting member and an out sole;

FIG. 13 is a perspective view wherein a part of the cup insole of another embodiment according to the method for forming the sole shape for the cup insole of the present invention, is cut off;

FIGS. 14(a) and 14(b) are longitudinal sectional views taken along line 14-14 of the cup insole in FIG. 13 placed in the footwear, wherein FIG. 14(a) shows the unused cup insole, and FIG. 14(b) shows the cup insole when used;

FIG. 15 is a perspective view of another embodiment of the cup insole in FIG. 13, wherein a part of the cup insole is cut off; and

FIGS. 16(a) and 16(b) are longitudinal sectional views showing another embodiment of the cup insole in FIG. 13, wherein FIG. 16(a) shows the unused cup insole where the blocking member is provided between the middle padding member and the supporting member, and FIG. 16(b) shows the unused cup insole where the blocking member is provided on the underside of the supporting member.

### DETAILED DESCRIPTION OF PREFERRED EMBODIMENTS

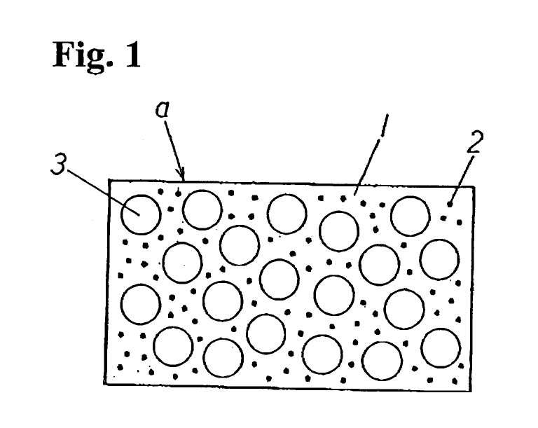

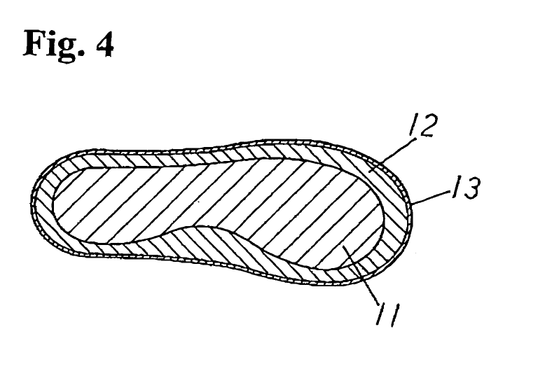

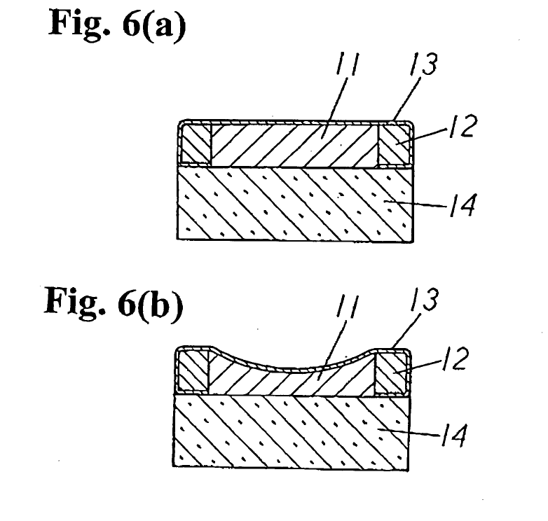

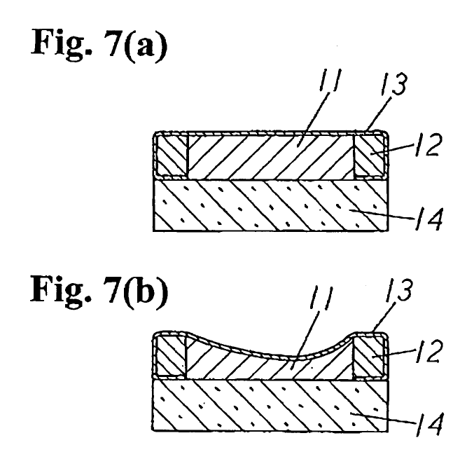

Preferred embodiments of the present invention will be explained with reference to FIGS. 1 through 16(a) and 16(b).

FIG. 1 shows a schematic cross sectional view of a resin foam that is used by a method for forming a sole shape for footwear and a method for forming a sole shape for a cup insole. The reference alphabet “a” represents the resin foam, the reference numeral 1 represents a resin matrix, and the reference numeral 2 represents fillers (fillers (C)), and the reference numeral 3 represents bubbles, respectively.

The resin matrix 1 composes the framework of the resin foam a, and is formed by low-density polyethylene (A) and ethylene-vinyl acetate copolymer (B) cross-linked by a cross-linker (E). The mass ratio between the low-density polyethylene (A) and the ethylene-vinyl acetate copolymer (B) is set such that (A)/(B)=95/5˜90/10, because in a property of the after-mentioned compressive residual strain rate, when the mass ratio of the low-density polyethylene (A) is less than 90/10, the value of the compressive residual strain rate becomes small. As a result, the retention capacity of a shape deformed by an external force deteriorates. Also, when the mass ratio of the low-density polyethylene (A) is over 95/5, decline of tensile strength increases, so that the shape may be easily broken.

The fillers 2 (fillers (C)) are added to allow for adjusting the hardness of the resin foam a. Its material is selected and its additive amount is adjusted according to usage. Therefore, for example, when the fillers 2 are used for an insole of footwear, micronized calcium carbonate, which can break up the bubbles 3 of the resin foam a, is used in order to receive appropriate feel on a sole when the footwear is put on. Preferably, the fillers 2 are added in such a way that the ratio between the total mass of the low-density polyethylene (A) and the ethylene-vinyl acetate copolymer (B) and the mass of the fillers (C) becomes ((A)+(B))/(C)=70/30˜80/20.

The bubbles 3 are formed in a state of closed cells by the foaming of a foaming agent (D) during the production process of the resin foam a.

Next, the production method of the resin foam a will be explained.

First, the low-density polyethylene (A), ethylene-vinyl acetate copolymer (B), fillers (C), foaming agent (D), and cross-linker (E) are mixed at a predetermined rate, and sufficiently kneaded, and a resin composition is blended.

The blended resin composition is foamed with a constant degree of temperature 140° C.˜180° C. and molded in such a way as to become a predetermined shape by using a formation method such as, for example, injection molding or extrusion molding, so that the resin foam a can be obtained.

Here, the cross-linker (E) allows a molecule of the low-density polyethylene (A) and a molecule of the ethylene-vinyl acetate copolymer (B) to be cross-linked by a cross-linking reaction and connected at the time of heating and foaming. The cross-linker (E) is made of materials such as dicumyl peroxide (DCP), and so on. Also, the foaming agent (D) forms the bubbles 3 in the resin foam a at the time of heating and foaming, and materials, such as, azodicarboxylic amide (AC) and so on, are used for the materials of the foaming agent (D).

Antimony oxide (Sb₂O₃) may be included in the resin composition. The antimony oxide enhances the flexibility of the molded resin foam a, especially when the antimony oxide is processed in a sheet-like shape, and therefore the molded resin foam a may be easily bent. Also, according to usage, a color former such as titanic oxide (TiO₂) or other additives may be added.

Next, the property of the resin foam a (embodiment) will be explained with a comparative example.

(1) Main materials used for the embodiment and comparative example, include:
Low-density polyethylene (A): Low-density polyethylene (LDPE) made by the Shanghai Petrochemical Co., Ltd.
Ethylene-vinyl acetate copolymer (B): Ethylene-vinyl acetate copolymer (EVA) made by the Beijing Yanhua Up-dated Hi-tech Co., Ltd.
Filler (C): Calcium carbonate (CaCO₃) made by the Zhejiang Linhua Industry Co., Ltd.
Foaming agent (D): Azodicarboxylic amide (AC) made by the Zhejiang Haihong Co., Ltd.
Cross-linker (E): Dicumyl peroxide (DCP) made by the Shanghai Petrochemical Co., Ltd.

(2) Composition of resin composition of the embodiment and the comparative example.

Composition of main materials of the resin composition of the embodiment and the comparative example is listed in Table 1 (each value in Table 1 indicates a mass portion, and values of the filler (C), foaming agent (D), cross-linker (E) indicate mass portions when a total mass of the low-density polyethylene (A) and ethylene-vinyl acetate copolymer (B) is a 100 mass portion. Also, although it is not shown in the Table 1, in both the embodiments 1˜3 and comparative examples 1 and 2, a 1.8 mass portion of the antimony oxide (Sb₂O₃) is added relative to the 100 mass portion of the total mass of the low-density polyethylene (A) and ethylene-vinyl acetate copolymer (B).

TABLE 1

| | | | | | Com- |
|---|---|---|---|---|---|
| | Embod- | Embod- | Embod- | Comparative | parative |
| Materials | iment 1 | iment 2 | iment 3 | Example 1 | Example 2 |
| Low-density | 90 | 93 | 95 | 80 | 100 |
| Polyethylene (A) | | | | | |
| Ethylene-vinyl | 10 | 7 | 5 | 20 | 0 |
| Acetate | | | | | |
| Copolymer (B) | | | | | |
| Filler (C) | 25 | 25 | 25 | 25 | 25 |
| Foaming Agent | 4.5 | 4.5 | 4.5 | 4.5 | 4.5 |
| (D) | | | | | |
| Cross-linker (E) | 0.7 | 0.7 | 0.7 | 0.7 | 0.7 |

As a measure of the property of the resin foam a, the compressive residual strain rate and tensile strength are selected. Table 2 shows a measured result of the above-mentioned properties of the embodiments and comparative examples. Each property is a measured value by the following assessment method.
Compressive residual strain rate:
   Test specimen 50 mm×50 mm×15 mm (d0=15 mm)
   Test temperature 15±1° C.
   Compression rate 53% (thickness before compression 15 mm, thickness at the time of the compression 7 mm)
   Compression time 3 hours
   Compressive residual strain rate (%)=(d0−dr)/d0×100

d0: Thickness before the compression (mm), dr: Thickness after the relief of compressive load (mm)
Tensile strength:
   JIS K6251 based on “Vulcanized rubber and thermoplastic rubber—How to find tensile property”

TABLE 2

| | | | | | Com- |
|---|---|---|---|---|---|
| | Embod- | Embod- | Embod- | Comparative | parative |
| Properties | iment 1 | iment 2 | iment 3 | Example 1 | Example 2 |
| Compressive | 33 | 40 | 53 | 20 | 53 |
| Residual Strain | | | | | |
| Rate (%) | | | | | |
| Tensile Strength | 0.67 | 0.38 | 0.30 | 1.40 | 0.19 |
| (MPa) | | | | | |

As shown in the Table 2, in the embodiments 1˜3 and comparative example 2, the property of the compressive residual strain rates has a higher value (tendency not to return to former state of thickness even if the compressive load is relieved) compared to the comparative example 1, and the comparative example 1 has a low value of 20% (tendency to return to the former state of thickness after the compressive load is relieved).

On the other hand, in the resin foam wherein the resin composition of the comparative example 2, which does not include the ethylene-vinyl acetate copolymer, is used, the compressive residual strain rate is high, as in cases of the embodiments 1˜3. However, the tensile strength of the comparative example 2 is 0.19 MPa, which is low compared to the embodiments 1˜3, and for practical purposes, cannot be used for the insole and the like (for example, if used for the insole, the tensile strength is required to be 0.20 MPa and higher).

However, due to the reasons described below, the compressive residual strain rate of the resin foam a, which is formed by increasing the mass ratio of the low-density polyethylene (A) relative to the ethylene-vinyl acetate copolymer (B), can be increased. A foam magnification ratio (enlargement ratio of volume) is increased by increasing the mass ratio of the low-density polyethylene (A), and a large number of bubbles 3 can be formed in the resin matrix 1.

Also, a large number of formed bubbles 3 are crushed by external force and plastic-deformed, and the deformed shape can be retained. In addition, in order to control the decline of the tensile strength of the formed resin foam a, and to ensure practical tensile strength, such as application into the insole, the upper limit of the mass ratio between the low-density polyethylene (A) and ethylene-vinyl acetate copolymer (B) is set in (A)/(B)=95/5. The lower limit of the mass ratio between the low-density polyethylene (A) and ethylene-vinyl acetate copolymer (B) is set according to (A)/(B)=90/10, because if the mass ratio becomes lower than that, the value of the compressive residual strain rate is decreased, and the retention capacity of the shape, which was deformed by the external force, deteriorates.

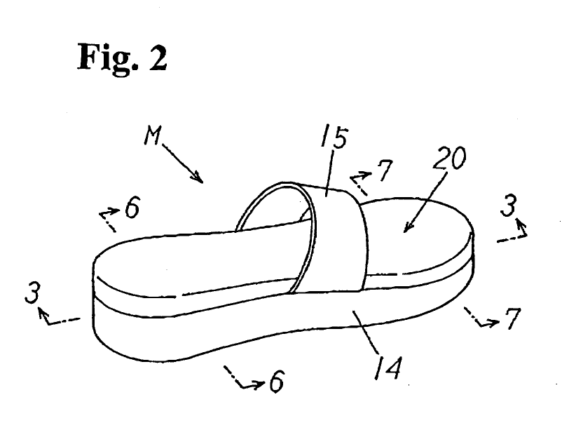

Next, an embodiment of the formation method for the sole shape for the footwear of the present invention will be explained with reference to FIGS. 2˜7(a) and 7(b).

In FIGS. 2˜4, the reference alphabet M represents the footwear, and the footwear M is provided with an insole 20 on an outsole 14. The insole 20 includes: a middle padding member 11 composed of the resin foam a; an outer padding member 12 formed in such a way as to surround the outer circumference of the middle padding member 11 (for example, formed in a frame manner in such a way as to surround the outer circumference of the middle padding member 11) by a harder member than the middle padding member 11; and a covering member 13 covering the outer surface of the outer padding member 12 and middle padding member 11. The reference numeral 15 represents a shell covering member, and the shell covering member 15 is provided when the footwear M is a sandal.

The middle padding member 11, molded in a predetermined shape by the resin foam a, retains the shape deformed by the external force, and fits the surface of the insole in the sole shape.

The outer padding member 12 prevents an excessive deformation, created by the external force, being added in the middle padding member 11, and further acts to retain the outer shape of the insole 20. The outer padding member 12 is made of, for example, ethylene-vinyl acetate copolymer foam, and the like, which is harder than the middle padding member 11 composed of the resin foam a.

The covering member 13 is made of makeup members and the like in order to improve the outside appearance of the footwear M. Moreover, the covering member 13 is preferably made of materials with elasticity in order to follow the deformation of the middle padding member 11 that abuts against the covering member 13.

The outsole 14 provides cushioning so that a foot does not directly receive a shock due to unevenness of the ground when the footwear M is grounded. The outsole 14 is made of polyurethane, the ethylene-vinyl acetate copolymer, synthetic rubber, and the like.

The shell covering member 15 abuts against an instep of the foot when the footwear M is put on. Shell covering member 15 fixes the foot to the footwear M, and is made of polyurethane, polyvinyl chloride, leather, and the like.

Next, usage of the footwear with the insole will be explained.

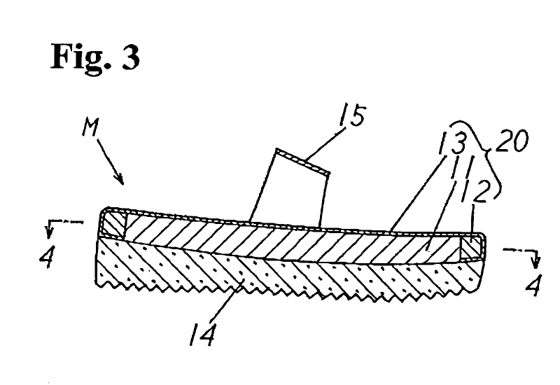

As shown in FIGS. 3, 6(a), and 7(a), when the footwear M is unused, the face wherein the foot is abutted has a roughly planar shape, since the external force has not yet been added in the insole 20.

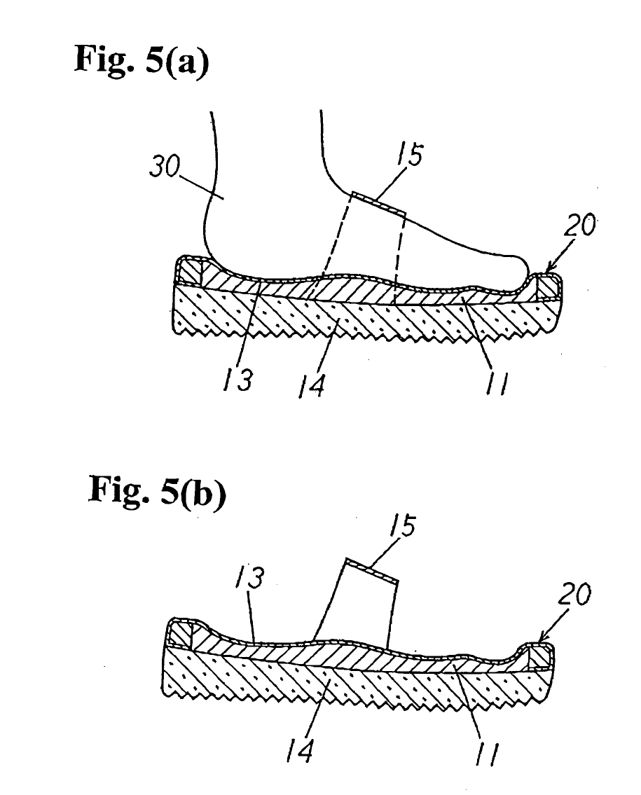

As shown in FIG. 5(a), when the footwear is initially used, the sole of a foot 30 abuts against the covering member 13 of the insole 20 for the first time, and the insole 20 is deformed by the external force (weight) on the sole. At this time, since there is unevenness in the shape of the sole contacting with the upper surface of the insole 20, each portion has a different settlement volume, and is deformed according to the shape of the sole. This deformation volume not only varies at each portion of the sole such as a toe, arch, and heel, but also the deformation volume greatly varies between individuals (difference of a sole shape).

Because the middle padding member 11, which is placed inside the insole 20, is composed of the resin foam a and has high moldability, as shown in FIGS. 5(b), 6(b), and 7(b), even after the footwear is taken off and the external force is removed, the shape of the sole is retained on the upper surface of the insole 20. Therefore, the shape of the sole which varies according to each person can be molded on the surface of the insole in a short time by use of the footwear (for example, approximately 3 hours), so that footwear which fits in each person's sole shape can be obtained without labor and time.

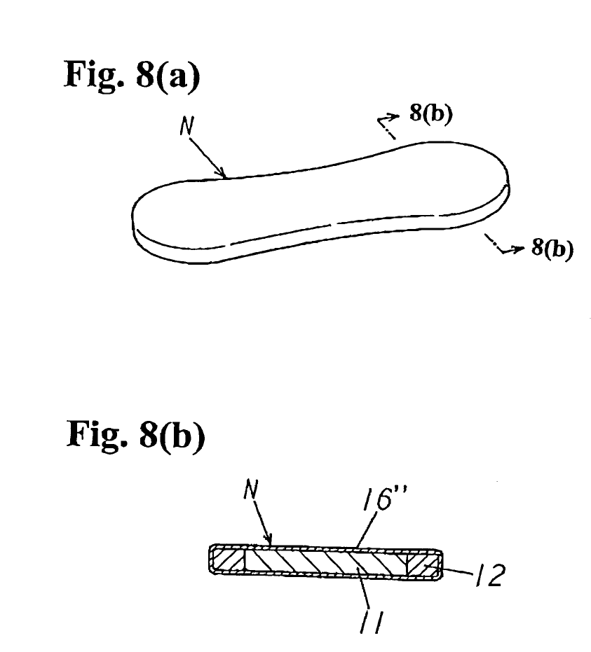

Next, an embodiment of the method for forming the sole shape for the cup insole will be explained with reference to FIGS. 8(a) and 8(b).

In the above-mentioned embodiment, an example of the footwear wherein the insole 20 and the outsole 14 are integrally provided beforehand is shown. Alternatively, as shown in FIG. 8(a), the insole may be made as a single piece of a cup insole N (removable insole in the footwear).

Cup insole N includes the middle padding member 11 composed of the resin foam a; the outer padding member 12 formed in such a way as to surround the outer circumference of the middle padding member 11 by harder materials than the middle padding member 11; and a covering member 16″ provided in such a way as to cover the whole outer padding member 12 and middle padding member 11 (refer to FIG. 8(b)). Therefore, because the cup insole N may be placed on the innersole of a variety of ready-made footwear, the shape of the sole, which varies between individuals, can be molded on the surface of the cup insole in a short time by use of footwear wherein the cup insole N is placed. As a result, footwear that fits the sole shape of each person can be obtained without labor and time. The covering member 16″ is made of similar materials as the covering member 13.

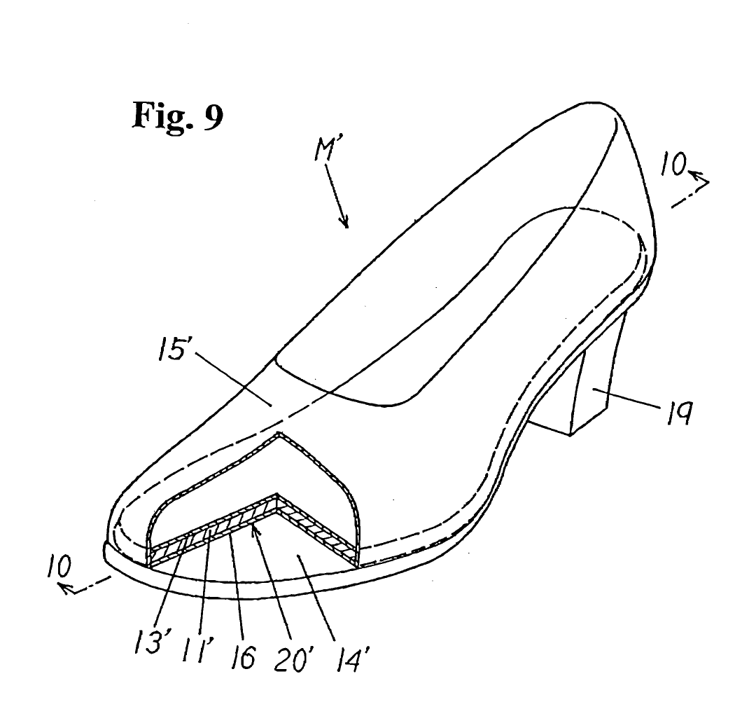

Next, another embodiment of the formation method for the sole shape for the footwear of the present invention will be explained with reference to FIGS. 9˜12(a) and 12(b). The reference alphabet M′ represents footwear according to the present invention, and includes an outsole 14′ and an insole 20′ that is provided on the outsole 14′. The insole 20′ and outsole 14′ are adhered by, for example, an adhesive. Also, according to need, a shell covering member 15′ or heel 19 is provided for the footwear M.

As shown in FIG. 9, the insole 20′ includes a sheet-like middle padding member 11′; a sheet-like supporting member 16 that has the same shape as the middle padding member 11′ in plan view and is located under the middle padding member 11′; and a covering member 13′ covering at least the upper surface of the middle padding member 11′. The abutting surface between the middle padding member 11′ and the supporting member 16 is adhered by the adhesive.

The middle padding member 11′ is plastic-deformed along the uneven shape of the sole due to the weight on the sole, and forms the uneven shape of the sole on the upper surface. The middle padding member 11′ comprises, for example, resin foam with a moldability property. More specifically, the resin foam a comprises a composition that includes the low-density polyethylene (A); the ethylene-vinyl acetate copolymer (B); the filler (C); the foaming agent (D); and the cross-linker (E) is foamed, and the mass ratio between the low-density polyethylene (A) and the ethylene-vinyl acetate copolymer (B) is set in (A)/(B)=95/5˜90/10.

When resin foam a is used, the footwear M′ provides the appropriate feel on the sole when the footwear M′ is put on, so that the ratio between the total mass of the low-density polyethylene (A) and the ethylene-vinyl acetate copolymer (B) and the mass of the filler (C) is preferably set in ((A)+(B))/(C)=70/30˜80/20.

The supporting member 16 supports the middle padding member 11′. In order to prevent the middle padding member 11′ from deforming in a roughly horizontal direction (in a longitudinal direction and/or width direction of the insole 20′) due to the friction between the sole and the insole 20′ when the footwear M′ is used, materials that are harder than the middle padding member 11′ are used. For example, resin sheets such as Ethylene-vinyl acetate copolymer (EVA), polyethylene, polypropylene, polystyrene, polyethylene terephthalate, polycarbonate, carbon and the like; resin foam sheets wherein the above-mentioned materials are foamed; rubber sheets such as natural rubber, styrene rubber, urethane rubber and the like; metal sheets such as aluminum, titanium and the like; or cardboard such as pasteboard, compressed paper and the like, are used.

The abutting surface between the middle padding member 11′ and the supporting member 16 is adhered by the adhesive. The adhesion site may range over the whole abutting surface between the middle padding member 11′ and the supporting member 16, or may be a part of the abutting surface such as the periphery of the abutting surface between the middle padding member 11′ and the supporting member 16.

Makeup members and the like are used for the covering member 13′ in order to improve the outside appearance of the footwear M′. Moreover, the covering member 13′ is preferably made by materials with elasticity in order to follow the plastic deformation of the middle padding member 11′ which abuts against the covering member 13′.

The outsole 14′ provides cushioning so that a foot does not directly receive a shock due to the unevenness of the ground when the footwear M′ is grounded, and is made of polyurethane, ethylene-vinyl acetate copolymer, synthetic rubber, and the like.

Next, the production of the insole 20′ which is a substantial part of the footwear M′ of the present invention will be explained. First, the supporting member 16 and the middle padding member 11′ are molded in such a way as to be the same shape in plan view by using a supporting member sheet wherein, for example, the ethylene-vinyl acetate copolymer (EVA) is foamed; and a middle padding member sheet comprises the above-mentioned resin foam a.

The supporting member 16 and middle padding member 11′ are then overlapped and laminated, and the abutting surface between the supporting member 16 and middle padding member 11′ is adhered by adhesive. The insole 20′ is formed by attaching the covering member 13 on the upper surface of the middle padding member 11′.

During the formation of the insole 20′, after the above-mentioned supporting member sheet and middle padding member sheet are adhered beforehand by the adhesive and laminated, the insole 20′ may be formed by molding an obtained laminated object and attaching the covering member 13′ on the upper surface of the middle padding member 11′. In other embodiments, after the supporting member sheet, middle padding member sheet, and covering member sheet are adhered beforehand by the adhesive and laminated, the insole 20′ may be formed by molding an obtained laminated object. Also, the molding method of the middle padding member 11′ and the supporting member 16 may be any heretofore known method, for example, the supporting member 16 and the middle-padding member 11′ may be laminated and molded by stamping and the like at the same time.

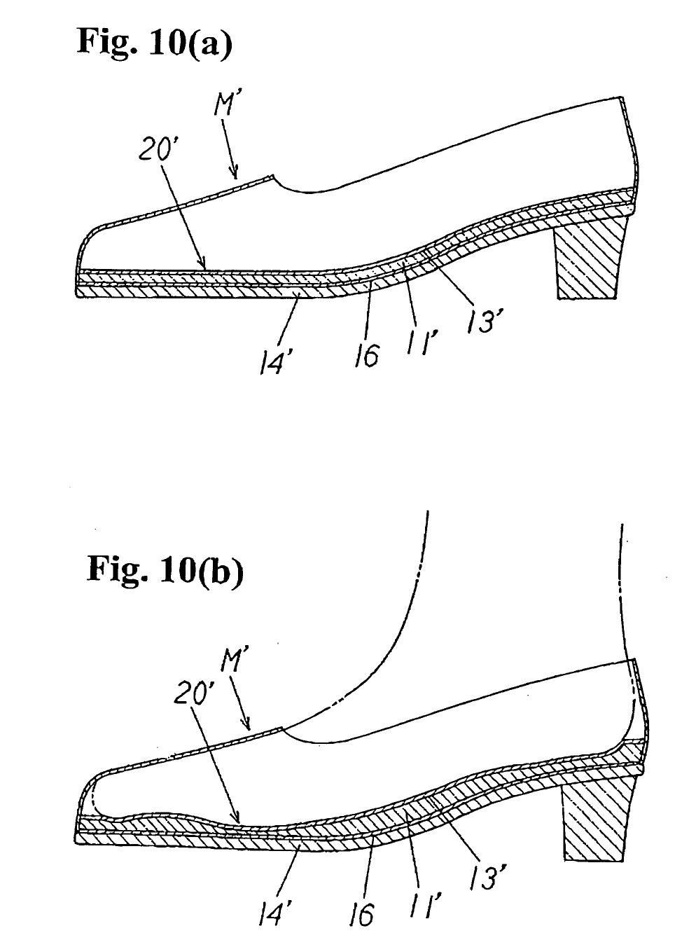

Next, the usage of the footwear M′ according to the present invention will be explained. FIG. 10(a) shows footwear M′ which is unused, and the upper surface of the insole 20′ is roughly flat. However, as shown in FIG. 10(b), after a short time of use, the upper surface of the middle padding member 11′ is plastic-deformed along the uneven shape of the sole by the weight on the sole, and the uneven shape of each person's sole is formed on the insole 20′.

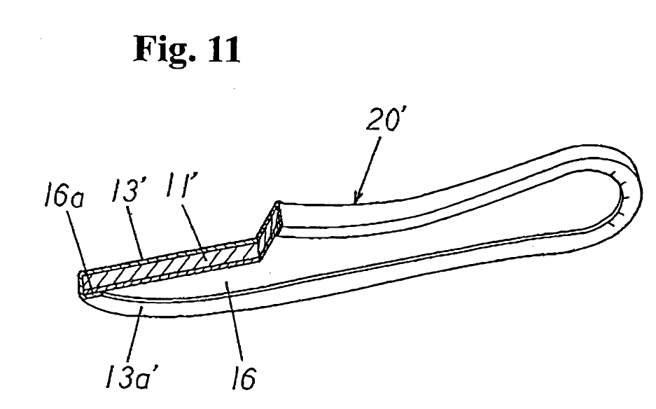

In the above-mentioned embodiment, a structure was disclosed wherein the abutting surface between the middle padding member 11′ and the supporting member 16 is adhered by the adhesive and fixed to each other. However, the structure may be as shown in FIG. 11. The middle padding member 11′ and the supporting member 16 are abutted against each other, and the upper surface of the middle padding member 11′ is covered by the covering member 13′. Also, the rim of the covering member 13′ is turned back, and on the undersurface of the supporting member 16, an abutting surface 16a between a turnback 13a′ of the covering member 13′ and the supporting member 16 is adhered by the adhesive.

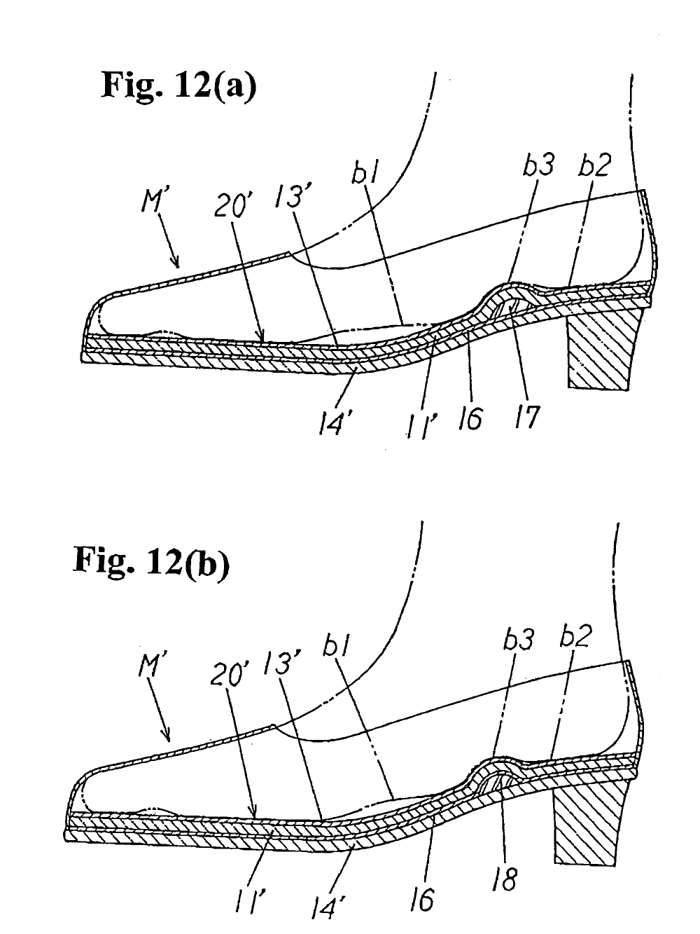

Also, as shown in FIG. 12(a), a blocking member 17 projecting toward the covering member 13′. Blocking the movement of the heel b2 may be provided at a site corresponding to a border b3 between a heel b2 and an arch b1 between the middle padding member 11′ and the supporting member 16. In other embodiments, as shown in FIG. 12(b), a blocking member 18 projecting toward the covering member 13′ and blocking the movement of the heel b2 may be provided at the site corresponding to the border b3 between the heel b2 and the arch b1 between the supporting member 16 and the outsole 14′. Due to the blocking members 17, 18, the sole can be fitted into the shape of each person's sole formed on the upper surface of the insole 20′ The footwear M′ shown in FIGS. 12(a), 12(b) is unused. For convenience sake, a foot is shown with a dashed-two dotted line, and the corresponding relationship between the sole and the insole 20′ is shown.

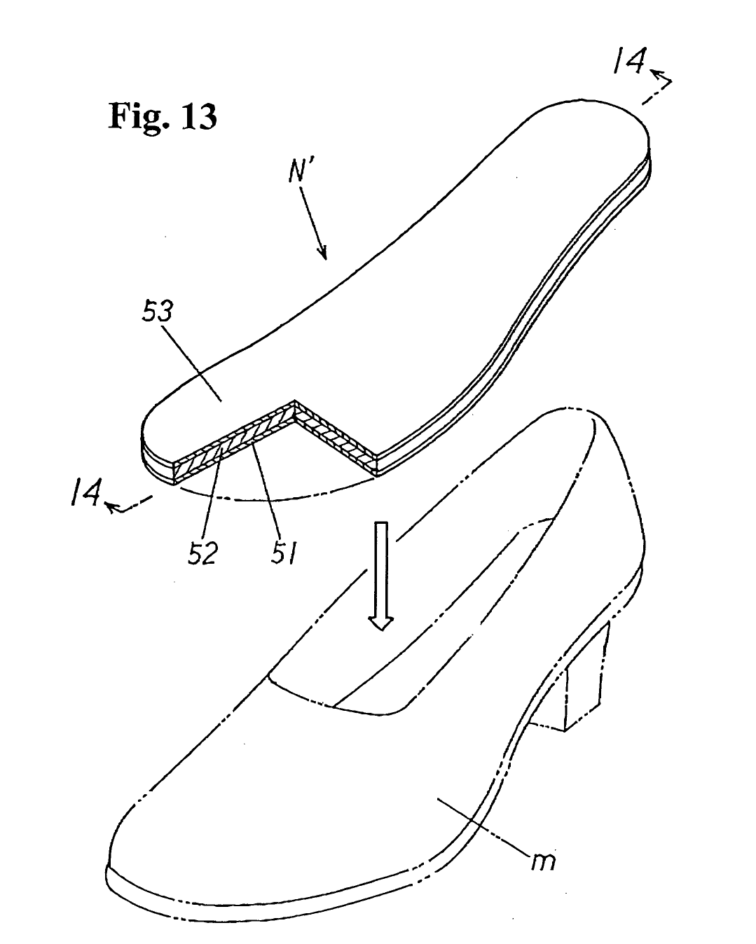

Next, another embodiment of the formation method for the sole shape for the cup insole of the present invention will be explained with reference to FIGS. 13˜16(a) and 16(b). The reference alphabet N′ represents a cup insole according to the present invention. As shown in FIG. 13, the cup insole N′ includes a sheet-like middle padding member 52; a sheet-like supporting member 51 that has the same shape as the middle padding member 52 in plan view and is located under the middle padding member 52; and a covering member 53 covering at least the upper surface of the middle padding member 52. The abutting surface between the middle padding member 52 and the supporting member 51 is adhered by the adhesive. The cup insole N′ is used by being placed on the insole of ready-made footwear m.

Each material of the supporting member 51, middle padding member 52, and covering member 53 is the same as the material of the supporting member 16, middle padding member 11′, and covering member 13′ of the above-mentioned embodiment. The structure and production method of the cup insole N′ is the same as those of the insole 20′ of the above-mentioned embodiment, so that the detail explanation is omitted.

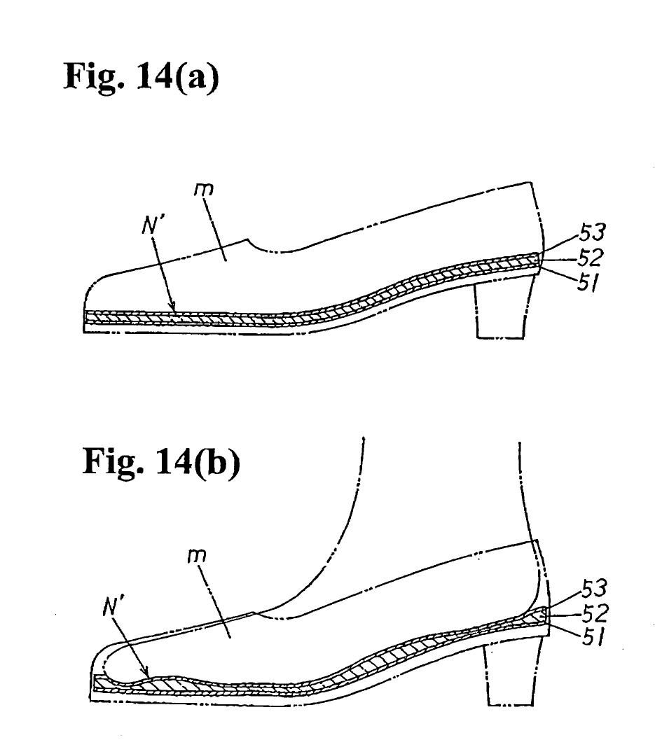

Next, usage of the cup insole N′ according to the present invention will be explained. FIG. 14(a) shows the state wherein the unused cup insole N′ is placed in the ready-made footwear m. The upper surface of the cup insole N′ is roughly flat, however, as shown in FIG. 14(b), after a short time of use, the upper surface of the middle padding member 52 is plastic-deformed along the uneven shape of the sole by the weight on the sole, and the uneven shape of each person's sole is formed on the cup insole N′.

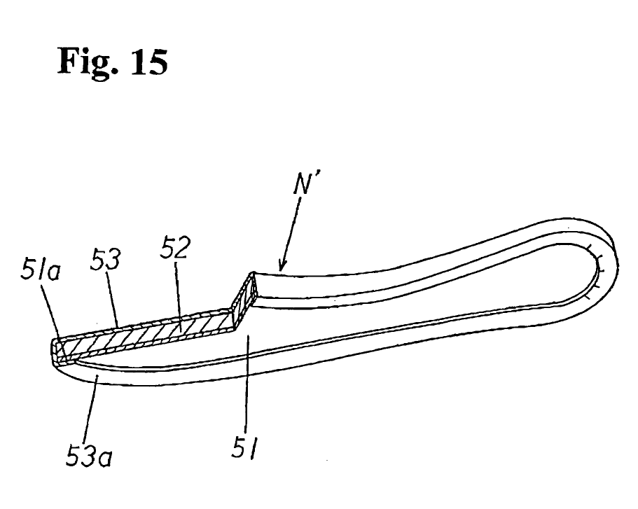

The disclosure above describes a structure, wherein the abutting surface between the middle padding member 52 and the supporting member 51 is adhered by the adhesive and fixed to each other. However, the structure may be as follows as shown in FIG. 15. The middle padding member 52 and the supporting member 51 are abutted against each other, and the upper surface of the middle padding member 52 is covered by the covering member 53. Also, the rim of the covering member 53 is turned back, and on the undersurface of the supporting member 51, an abutting surface 51a between a turnback 53a of the covering member 53 and the supporting member 51 is adhered by the adhesive.

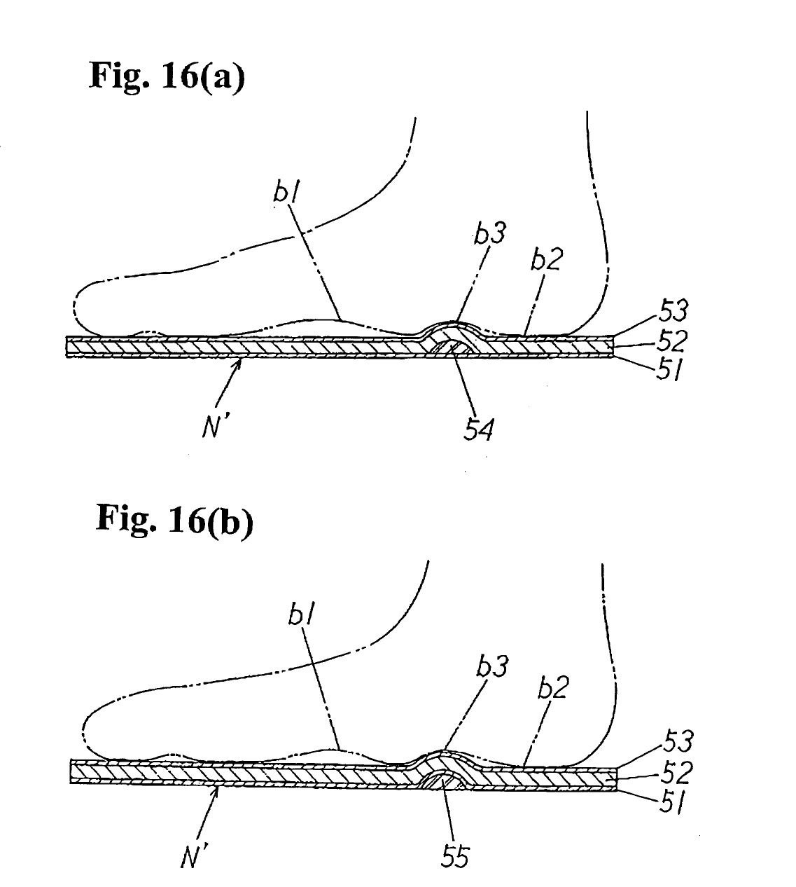

Also, as shown in FIG. 16(a), a blocking member 54 projecting toward the covering member 53 and blocking the movement of the heel b2 may be provided at the site corresponding to the border b3 between the heel b2 and the arch b1 between the middle padding member 52 and the supporting member 51. Alternatively, as shown in FIG. 16(b), a blocking member 55 projecting toward the covering member 53 and blocking the movement of the heel b2 may be provided at the site corresponding to the border b3 between the heel b2 and the arch b1 under the supporting member 51. Due to the blocking members 54, 55, the sole may be fitted into the shape of each person's sole formed on the upper surface of the cup insole N′. The cup insole N′ shown in FIGS. 16(a), 16(b) is unused. The foot is shown with the dashed-two dotted line, and the corresponding relationship between the sole and the cup insole N′ is shown.

The disclosure of Japanese Patent Applications No. 2006-63729 filed on Mar. 9, 2006 and No. 2006-286026 filed on Oct. 20, 2006 are incorporated as references.

While the invention has been explained with reference to the specific embodiment of the invention, the explanation is illustrative, and the invention is limited only by the appended claims.

What is claimed is:

1. A method for forming a sole shape in a cup insole, comprising:
producing a closed cell resin foam formed of a foamed resin composition including low-density polyethylene (A), ethylene-vinyl acetate copolymer (B), filler (C), foaming agent (D), and cross-linker (E), a mass ratio of the low-density polyethylene (A) and the ethylene-vinyl acetate copolymer (B) being such that (A)/(B) is within a range of 90/10 to 95/5;
molding the resin foam into a predetermined shape to form a middle padding member deformable by an external force; and
covering the middle padding member with an elastic covering member configured to follow deformation of the middle padding member that abuts the covering member;
wherein the covering member is configured to be abutted against a foot, and weight on a sole allows a plurality of bubbles formed in said resin foam to be crushed for plastic-deformation thereof so that the resin foam is deformed along a shape of the sole.

2. A method for forming a sole shape according to claim 1, further comprising:
inserting a sheet supporting member under the middle padding member for supporting the same, said supporting member having a shape of the middle padding member and being harder than said middle padding member; and
adhering an abutting surface between said middle padding member and said supporting member.

3. A method for forming a sole shape according to claim 1, further comprising:
inserting a sheet supporting member under the middle padding member for supporting the same, said supporting member having a shape of the middle padding member and being harder than said middle padding member;
wherein the covering member covers an upper surface of said middle padding member and further comprises a rim turned back and located on an undersurface of said supporting member; and
adhering the turnback of the covering member and said supporting member at an abutting surface therebetween.

4. A method for forming a sole shape according to claim 2, further comprising:
providing a blocking member projecting toward said covering member for blocking movement of a heel at a site corresponding to a border between the heel and an arch between said middle padding member and said supporting member, or under the supporting member.

5. A method for forming a sole shape according to claim 3, further comprising:
providing a blocking member-projecting toward said covering member for blocking movement of a heel at a site corresponding to a border between the heel and an arch between said middle padding member and said supporting member, or under the supporting member.

6. A method for forming a sole shape according to claim 1, wherein the closed cell resin foam is prepared such that a ratio between total mass of the low-density polyethylene (A) and mass of the ethylene-vinyl acetate copolymer (B); and mass of the filler (C) is produced according to ((A)+(B))/(C) within a range (70/30)-(80/20).

7. A method for forming a sole shape for footwear, comprising:
preparing the middle padding member with the elastic covering member according to claim 1, to thereby form an insole, and
providing the insole on an outsole,
wherein when the foot is put on the covering member and weight on the sole is applied on the covering member, a plurality of bubbles formed in said resin foam is crushed for plastic-deformation so that the resin foam is deformed along a shape of the sole.

8. A sole for an insole, comprising:
a middle padding member comprising resin foam; and
a covering member for covering the middle padding member;
wherein said resin foam is a foamed resin composition including low-density polyethylene (A), ethylene-vinyl acetate copolymer (B), filler (C), foaming agent (D), and cross-linker (E), and a mass ratio of the low-density polyethylene (A) and ethylene-vinyl acetate copolymer (B) is set such that (A)/(B) is within a range 90/10 to 95/5; and
the covering member is configured to be abutted against a foot, and weight on a sole allows a plurality of bubbles formed in said resin foam to be crushed for plastic-deformation so that the resin foam is deformed along a shape of the sole.

9. A sole according to claim 8, further comprising:
a sheet-like supporting member having a shape of said middle padding member and being harder than said middle padding member, said supporting member being located under said middle padding member and supporting said middle padding member;
wherein the covering member covers at least an upper surface of said middle padding member, and an abutting surface between said middle padding member and said supporting member is adhered.

10. A sole according to claim 8, further comprising:
a sheet supporting member inserted under the middle padding member for supporting the same, said supporting member having a shape of the middle padding member and being harder than said middle padding member,
wherein the covering member covers an upper surface of said middle padding member and further comprises a rim turned back and located on an undersurface of said supporting member, the turnback of the covering member and said supporting member being adhered at an abutting surface therebetween.

11. A sole according to claim 9, further comprising:
a blocking member projecting toward said covering member for blocking movement of a heel at a site corresponding to a border between the heel and an arch between said middle padding member and said supporting member, or between the supporting member and an outer sole.

12. A sole according to claim 10, further comprising:
a blocking member projecting toward said covering member for blocking movement of a heel at a site corresponding to a border between the heel and an arch between said middle padding member and said supporting member, or between the supporting member and an outer sole.

13. A sole according to claim 8, wherein the closed cell resin foam includes a ratio of total mass of the low-density polyethylene (A) and mass of the ethylene-vinyl acetate copolymer (B) relative to mass of the filler (C), ((A)+(B))/(C) being within a range (70/30)-(80/20).

14. A sole according to claim 8, wherein the sole is adapted for a cup insole.

15. A sole according to claim 8, wherein the sole is adapted for footwear including an insole provided on an outsole.
